(19) United States
(12) Patent Application Publication
(10) Pub. No.: US 2005/0130783 A1
(43) Pub. Date: Jun. 16, 2005

(54) Gear mechanism for use in controlling vehicle rear-view mirrors and measuring angular deflection of an articulated trailer relative to the tractor

(76) Inventor: John Standen, Daventry (GB)

Correspondence Address: Thomas E Sisson;Jackson Walker, Attorney at Law, 112 E. Pecan Street, Suite 2100, San Antonio, TX, 78205-1521, US

(21) Appl. No.: 10/506,280

(22) PCT Filed: Feb. 25, 2003
(86) PCT No.: PCT/GB03/00781

(30) Foreign Application Priority Data
Mar. 1, 2002 (GB) 0204820.5

(51) Int. Cl. F16H 35/02

(52) U.S. Cl. 475/15

(57) ABSTRACT

A gear mechanism, for example for controlling the rotation of vehicle rear-view mirrors, comprises a first sun gear (1) driving a first set of planet gears (5, 6, 7, 8) which mesh with a first ring gear (9), a second set of planet gears (5, 6, 7, 8) of different diameter to the gears of the first set, the gears in the second set meshing with a second ring gear (10) but not with the first sun gear, the first and second ring gears being located side-by-side and relatively rotatable, wherein the each planet gear in the first set of planet gears is rigidly connected to a respective one of the planet gears in the second set so as to be rotatable therewith. Various devices for detecting the relative angle between a tractor and trailer vehicle so as to control the steering of a mirror are also disclosed, as well as means for zeroing the mirror position automatically.

### FIELD OF THE INVENTION

This invention relates to a gear mechanism for use, for example, in rotating vehicle rear-view mirrors, and to apparatus for measuring the angular deflection of an articulated trailer relative to the tractor vehicle, for example for controlling the steering of rear-view mirrors.

### BACKGROUND TO THE INVENTION

Various proposals have been made for devices to measure the angle between an articulated tractor and trailer and to control the rotation of cab-side mounted rear-view mirrors accordingly. The present invention seeks to improve on these known devices, both in the detection of the angle and in the control of movement of the mirrors.

### SUMMARY OF THE INVENTION

According to a first aspect of the invention, there is provided a gear mechanism comprising a first sun gear driving a first set of planet gears which mesh with a first ring gear, a second set of planet gears of different diameter to the gears of the first set, the gears in the second set meshing with a second ring gear but not with the first sun gear, the first and second ring gears being located side-by-side and relatively rotatable, wherein the each planet gear in the first set of planet gears is rigidly connected to a respective one of the planet gears in the second set so as to be rotatable therewith.

Preferably, the mechanism comprises a second sun gear rigidly connected to the first sun gear so as to rotate therewith and located on the opposite side of the second planet gears from the first planet gears, and a third set of planet gears meshing with the second sun gear, each planet gear in the third set of planet gears being rigidly connected to a respective one of the planet gears in the second set so as to be rotatable therewith. The third planet gears in engagement with the second sun gear serve to enhance the stability of the joined planet gears of the first and second sets, in particular avoiding any tendency of each gear to rotate about a plane normal to the axis of rotation thereof.

A motor may be provided to drive the sun gear. The output shaft may pass through the mechanism if the motor is offset or may protrude from one end only. The mechanism has similarities to both planetary gearboxes and harmonic drives and provides a large reduction ratio with a very low level of friction, thereby achieving a high level of efficiency. Preferably, the sun gear comprises a an internal gear section driven by a gear on the motor.

Some previous actuator designs have utilised two internal gears of different sizes coupled with a common planet gear. The planet gear can only mate correctly with one internal gear and backlash exists in the mechanism as a result. This arrangement is only adequate if the backlash is acceptable in the target application.

This mechanism achieves minimal backlash by coupling two internal gears by a planet gear that has two gear sections, each of which correctly mates with one of the internal gears.

The difference in tooth count of the two internal gears must equal the number of planet gears fitted, or be a multiple thereof.

Backlash in the mechanism can be controlled to very tight limits. Manufacturing the parts from materials having similar expansion characteristics regarding temperature and humidity will ensure that performance is maintained during environmental changes.

The design spreads torsional loads evenly among the planet gears. It will be possible to adjust backlash by rotating opposite planet gears relative to the other two although this will decrease the number of planets sharing the load and therefore increase stress on the gear teeth.

Advantages of the mechanism of the invention include simplicity in construction, since no spindles or bearings, or indeed any mountings, are required for the planet gears, properly-meshing gears, since all the gear teeth are correctly shaped and sized for accurate engagement, ease of manufacture, and ease of sealing against ingress of water. The gear mechanism has little or no backlash and is quiet in operation. It may be used, for example, to turn a steerable rear-view mirror for an articulated vehicle or the like.

In systems which detect the angle between an articulated trailer and its tractor unit, in order to control the steering of a rear-view mirror to ensure that the driver can see along the side of the trailer when turning, it is difficult to provide an absolute angle signal; errors arise in the sensing devices due to such factors as wear or play in the fifth wheel connection, vibration or slipping in the mechanism itself. Typically, the system will be provided with a zeroing button which the driver can press to reset the centre position of the system when the trailer and tractor are aligned. A problem with this arrangement is that the driver may overlook the need to do this when travelling in a straight line, and only discover the resultant non-zero error when manoeuvring. It is therefore desirable to have a system which automatically resets the centre point of the system.

Sensors that provide a relative output of trailer angle require zeroing so that the absolute angle can be determined. The system needs to know the trailer angle relative to the straight position in order to accurately control the mirror position. The sensor needs to be zeroed when a trailer is first coupled to the tractor unit but may need to be periodically re-zeroed if the sensor measurement technique is prone to drift.

This zeroing could be achieved manually by the driver when the vehicle is in a straight line although this is inconvenient and adds another distraction to the driver. Due to the nature of the system, a driver may be unsure whether the system zero has drifted or if the vehicle is indeed slightly turned.

A system that detects when the tractor and trailer are in the straight position offers the ability to automatically zero the trailer angle sensor. This feature will improve safety by ensuring that the mirror angle is always correctly zeroed as well as making the system operation more convenient for the driver.

According to another aspect of the invention, therefore, there is provided a system for controlling the angle of vehicle rear-view mirrors on an articulated vehicle according to the angle between the tractor and trailer, the system comprising detector means for detecting a change in angle between the tractor and trailer and control means for providing a steering signal to move the mirrors relative to a rest position according to the detected change, the system comprising means for detecting when the tractor and trailer are substantially aligned one with the other, and means for providing a reset signal to return the mirrors to the rest positions thereof in response thereto.

Preferably, the system comprises means for detecting the speed of the vehicle and for signalling the speed to the control means, and wherein the control means comprises means for providing a reset signal to return the mirrors to the rest positions thereof in response to the detected speed being in excess of a predetermined speed for a predetermined period of time.

More preferably, the control means comprises memory means for storing settings corresponding to the rest position of the mirrors, for example as set manually by the driver. The control means is then arranged to add to the stored settings calculated offset values according to the detected angle between the tractor and trailer. The reset signal is then arranged to set the offset values to zero, thereby causing the mirrors to be returned to the rest positions thereof.

The vehicle speed sensor may be utilized if possible, otherwise it will be necessary to add an extra sensor. A possible method would be to use a proximity sensor to detect prop shaft rotation by triggering from a universal joint.

An alternative method of providing a zeroing signal is the use of GPS position output to show that the vehicle is travelling in a straight path. The GPS position output may be used to indicate speed, the speed then being used to control the re-set of the mirrors as hereinbefore described, or it may indicate direction, absence of change of direction being used to indicate alignment of the tractor and trailer and thus to provide the re-set signal.

Another aspect of the invention provides apparatus for providing a control signal proportional to the relative angle between an articulated tractor and trailer, the apparatus comprising a rotary sensor mounted on the tractor at a position to one side of the coupling between the trailer and tractor, an extensible link connected to the sensor and having anchoring means at the free end thereof for attachment to a position on the trailer, and control means having input means for inputting values for the distance from the coupling to the sensor and the distance from the sensor to the anchoring means when attached to the trailer when the trailer is aligned with the tractor, and for applying corrections to the output from the rotary sensor in accordance with the measured angle such that the output approximates more closely to the instantaneous angle between the tractor and the trailer.

The control means preferably comprises processing means to calculate correction factors by applying the input distance values to a predetermined formula for each measured angle. This may be done at the rate at which angular measurements are made by the rotary sensor, for example on a sampling basis, or the calculations may be carried out on setup of the device, the results being stored in a look-up table, for example in an EEPROM, to output corrected angular measurements in response to receipt of each measurement from the rotary sensor.

In yet another aspect of the invention, a device for measuring changes in angle between an articulated tractor and trailer, the trailer having a generally vertical king pin engaging in a coupling socket therefore on the tractor, the device comprising rotatable means engageable with the king pin so as to rotate therewith, and signal means for generating a signal in response to rotation of the rotatable means.

The rotatable means may comprise a rotatably mounted contact plate mounted relative to the coupling socket so as to be biased into engagement with the lower end of the king pin so as to rotate therewith.

Preferably, the contact plate is carried by resilient mounting means allowing a degree of movement relative to the coupling device sufficient to permit the contact plate to follow any movement of the king pin relative to the coupling device, in use. The resilient mounting means is suitably clamped to the coupling socket structure. For example, some configurations of coupling socket have around the underside an upstanding wall to which the mounting means may be clamped. Different mounting means may be provided to suit different forms of coupling socket arrangement on the fifth wheel structure.

The contact plate preferably has an angled rim therearound to assist in centring the contact plate on the end of the king pin. More preferably, the rim is discontinuous, for example giving a castellated appearance to the plate, to avoid the plate becoming filled with grease and/or dirt from the king pin. The rim may also comprise a series of springs arranged to grip the king pin. The springs may be formed from sheet material.

Alternatively, the rotatable means comprises a wheel mounted on a generally vertical axle and biased into engagement with the side of the king pin so as to rotate therewith.

The wheel or roller is preferably provided with a rubber surface or the like to engage the king pin, so as to ensure good frictional contact therewith. The wheel may be biased into engagement with the king pin by means of resilient means co-operating with the axle, for example a helical compression spring.

The axle may in turn be mounted on a lever carried by mounting means attachable to the fifth wheel structure on the tractor, for example by means of clamps or the like which do not require any permanent alteration to the fifth wheel structure.

A still further aspect of the invention provides apparatus for measuring changes in angle between an articulated tractor and trailer having a fifth wheel type of coupling, the apparatus comprising a plurality of first ultrasonic transducers mounted around the axis of the coupling at known distances therefrom and at known angles to the longitudinal axis of the tractor, a second ultrasonic transducer mountable on the trailer in a position such that, at any angle between the tractor and the trailer, there is an uninterrupted path between the second transducer and at least two of the first transducers, and control means for causing an ultrasonic signal to be sent between the first and second transducers and for detecting the relative transit times between at least two of the first transducers and the second transducer and for calculating therefrom the instantaneous angle between the tractor and trailer.

The first transducers may be receivers and the second transducer may be a transmitter, or vice versa. The transducers may be connected to the control means by wires or by a wireless link, for example a radio link.

To compensate for changes in the speed of sound resulting from changes in air temperature or pressure, calibrating measurements may be made by transmitting an ultrasound signal between a fixed pair of transducers mounted adjacent to the fifth wheel coupling, or by detecting the minimum transit time between any of the first transducers and the second transducer as the trailer rotates relative to the tractor and comparing this with a reference value for the apparatus.

Yet another aspect of the invention provides a device for measuring changes in angle between an articulated tractor and trailer, the device being of the type comprising a roller freely rotatably mounted on a generally horizontal axle carried by a pivoted lever provided with biasing means to bring the roller into engagement with the underside of the trailer, in use, and means for generating a signal in response to rotation of the roller.

While this type of arrangement is known from U.S. Pat. Nos. 5,896,235 and 5,684,647 for example, in each case the lever is mounted at a distance from the fifth wheel arrangement, and the apparatus therefore depends on the trailer presenting a suitably flat underside profile at the correct location for engagement of the roller.

In accordance with this aspect of the present invention, the device comprises a mounting attachable directly to the fifth wheel structure so that the roller engages the underside of the trailer immediately adjacent to the structure, in use.

The means for generating the position signal may comprise an incremental shaft encoder, providing both movement and direction of movement.

The roller distance from the centre of the fifth wheel is known and the trailer rotation angle can thus be calculated. The sensor mechanism may be attached to the rim of the fifth wheel by a simple clamp arrangement. This method offers a very simple method of mounting to existing fifth wheels without affecting the structural integrity of the equipment. This avoids any type approval issues which would arise if the fifth wheel was structurally modified.

The sensor mount is designed so that with no trailer fitted to the vehicle, the roller protrudes above the mating face of the fifth wheel slipper plate. When the trailer is coupled the underside of the trailer deflects the sensor, causing the roller to be pressed against the underside of the trailer.

The sensor may be mounted on the periphery of the fifth wheel slipper plate or within the lead-in slot to the rear of the plate. Mounting within the lead-in slot has the advantage of allowing operation with trailers that have a small contact area that does not extend beyond the periphery of the slipper plate. The disadvantage of this mounting position is that the sensor will be prone to damage by the king pin during trailer coupling.

Wear on the trailer king pin or the fifth wheel bearing mechanism will allow some unwanted movement of the king pin relative to the fifth wheel to occur. Depending on the direction relative to the roller axis, this movement may cause an unwanted rotation of the sensor, resulting in an erroneous angle measurement.

Fitting more than one sensor at different locations around the fifth wheel will allow the system to discriminate between real trailer rotation and unwanted kingpin movement. Trailer rotation will cause all sensors to turn equally in the same direction. Unwanted fifth wheel movement will cause dissimilar rotation angles in different sensors and allow the unwanted movement to be subtracted from the true signal.

A still further aspect of the invention provides apparatus for measuring changes in angle between an articulated tractor and trailer, the apparatus comprising a first inertial sensor device on the tractor, a second inertial sensor device on the trailer, and control means for comparing signals from the two sensor devices to provide an indication of the relative angle between the tractor and trailer.

Preferably, the inertial sensor devices each comprise an inertial element mounted in a carrier for free rotation relative to the carrier about a vertical axis, and means for detecting a change in angle between the inertial element and the carrier.

The inertial element may comprise a weight carried by a vertical shaft mounted on low-friction bearings, for example ball- or roller-bearings. The system may incorporate means for preventing unwanted rotation of the inertial element. This may comprise a braking device which is operated when the vehicle is held in a straight position, when no rotation should be occurring. Alternatively, the inertial element is a gyroscope spinning about a horizontal axis and mounted in a frame which is itself rotatably mounted about a vertical axis.

The sensors may be connected to the vehicle by cables, or alternatively may be self-contained devices provided with battery electric power and communicating with the control means by a radiated signal such as radio.

In an alternative embodiment of the invention, apparatus for measuring changes in angle between an articulated tractor and trailer comprises a first magnetic direction sensor on the tractor, a second magnetic direction sensor on the trailer, and control means for comparing signals from the two sensors to provide an indication of the relative angle between the tractor and trailer.

### BRIEF DESCRIPTION OF THE DRAWINGS

In the drawings, which illustrate exemplary embodiments of the various aspects of the invention:

FIG. 1 is a vertical cross-sectional view through a gear mechanism according to a first aspect of the invention;

FIG. 2 is a part-sectioned perspective view of the upper part of the mechanism of FIG. 1;

FIG. 3 is a diagrammatic top plan view of a tractor and trailer incorporating an angle sensor according to one aspect of the invention;

FIG. 4 is a perspective view of an angle sensor engageable with the lower end of a king pin;

FIG. 5 is a side elevation of the angle sensor of FIG. 4, illustrating engagement with the king pin;

FIG. 6 is a perspective view of an alternative type of sensor for direct engagement with the king pin;

FIG. 7 is a diagrammatic top plan view of a tractor and trailer incorporating an ultrasonic angle detection system according to another aspect of the invention;

FIG. 8 is an enlarged sectional view through a portion of the fifth wheel mounting of the tractor of FIG. 7, showing the mounting of an ultrasonic transducer thereon;

FIG. 9 is a plan view of the slipper plate of the fifth wheel connection of a tractor vehicle, having an angle sensor according to yet another embodiment of the invention;

FIG. 10 is a sectional view through a portion of the fifth wheel mounting of FIG. 9, showing the mounting of the angle sensor thereon;

FIG. 11 is a side elevation of a portion of the fifth wheel mounting of FIG. 9 with the angle sensor mounted thereon, shown in the rest position; and

FIG. 12 is a view corresponding to that of FIG. 11, showing the angle sensor in the operative position thereof.

### DETAILED DESCRIPTION OF THE ILLUSTRATED EMBODIMENTS

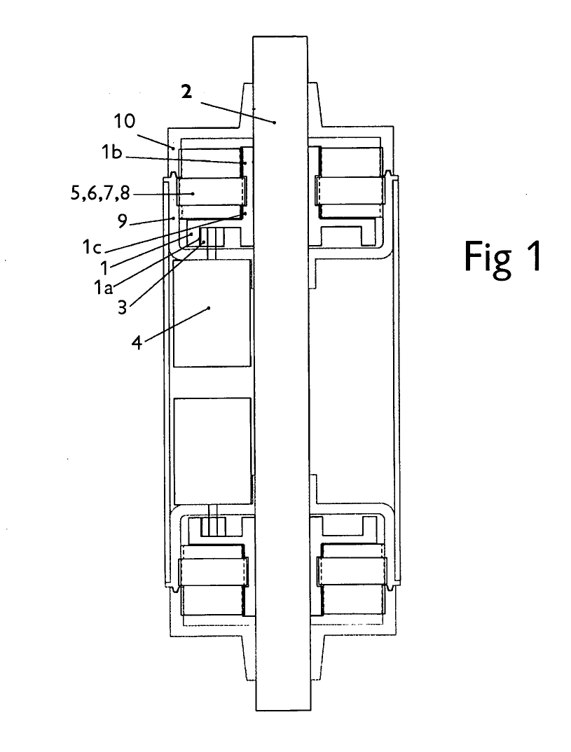

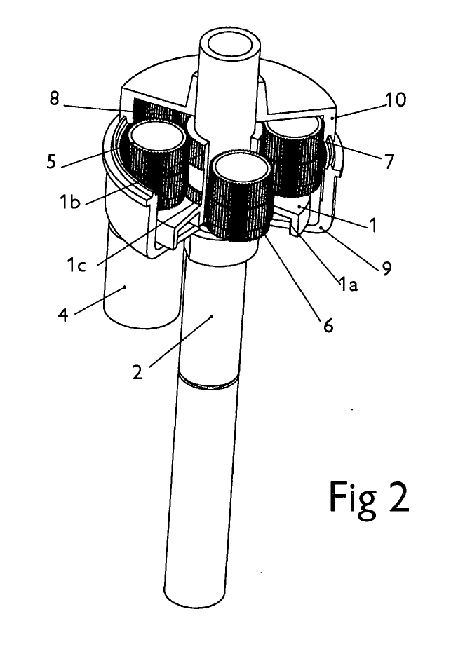

Referring first to FIGS. 1 and 2, the gear mechanism provides a compact design that is constructed coaxially to the output shaft. A sun gear 1 has a bore which is free to rotate on the output shaft 2. It has an internal gear section 1a which is driven by a gear 3 mounted on the shaft of a motor 4. The sun gear 1 has two other gear sections 1b and 1c, which are geometrically part of a larger gear but divided into two regions by a groove.

Four planet gears 5, 6, 7 and 8 each incorporate two diameters of gear, with the largest gear section being approximately in the middle and dividing the smaller gear size into two sections. The planet gears are distributed evenly around the sun gear. The smaller diameter gear sections of the planet gears mate with the sun gear sections 1b and 1c. The groove in the sun gear provides clearance for the larger gear sections of the planet gears.

A stator 9 has a bore which acts as a bearing to support the output shaft 2. It has an internal gear section which engages with the larger gear sections of the planet gears. The stator also provides a means of mounting the motor 4 at the correct distance from the sun gear 1 which runs on the output shaft 2.

The output gear 10 also has a bore section which acts as a bearing against the output shaft 2. It has an internal gear section which has 4 fewer teeth than the internal gear section of the stator 9. This internal gear mates with the longer of the smaller diameter gear sections of the planet gears.

As the sun gear is rotated by the motor, the planet gears are caused to process around it as the smaller gear sections of each planet gear are engaged with the sun gear and the larger gear section of each planet gear are engaged with the stator. Each full orbit of the planet gears causes the output gear to be rotated by four teeth, this being the difference between the internal gears of the stator and output gear.

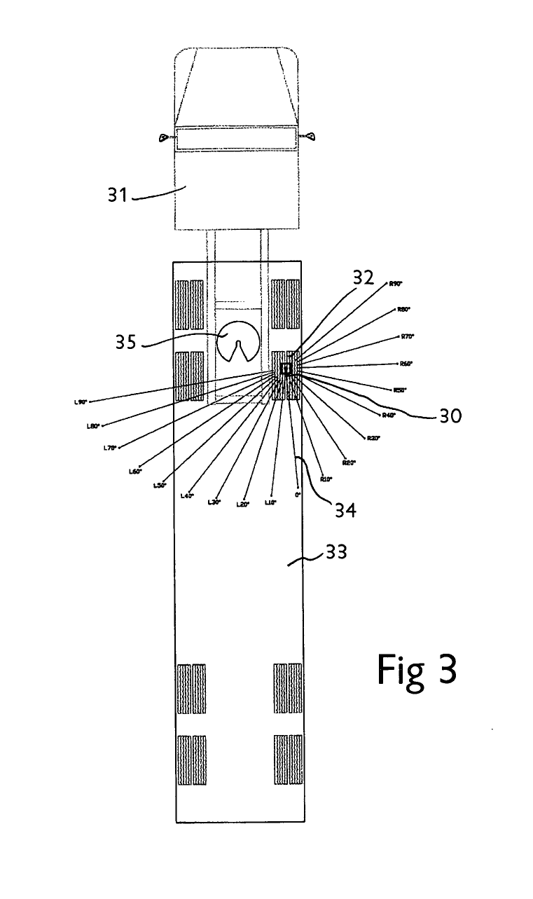

Referring now to FIG. 3, the sensor comprises a radial arm 30 mounted onto the shaft of a rotary sensor such as a potentiometer or incremental shaft encoder. The sensor may be permanently or detachably mounted at the side of the tractor unit 31 near the rear wheels 32. A suitable attachment point would be on the rear mudguard if this is fitted, otherwise to a simple bracket in the vicinity.

The end of the radial arm 30 is connected to the trailer 33 by an elastic member 34. A suitable point of attachment would be the side of the trailer landing leg frame. The tension of the elastic causes the sensor's radial arm to always point to the attachment point on the trailer. The rotation angle of the sensor can be used to indicate tractor to trailer angle once the necessary corrections have been performed.

The sensor will be mounted at a height whereby the radial arm and elastic will be between the top of the wheel or mudguard and the bottom of the trailer. When mounting the sensor it is necessary to ensure that the elastic will not contact the fifth wheel during turns. As the vehicle turns the trailer rotates relative to the tractor unit, with the pivot point being where the trailer's king pin is engaged with the tractor's fifth wheel coupling 35. Because the sensor mounting position is offset from the trailer pivot point, the sensor rotation angle is not equal to the trailer rotation angle.

Due to the sensor being mounted away from the centre line of the vehicle, the relationship between trailer rotation angle and sensor rotation angle is not the same between left and right turns. The location of the sensor relative to the fifth wheel pivot point can be determined at the time of installation and stored within the control system. The distance from the sensor to the elastic attachment point on the trailer will depend on individual trailer design and can be inputted to the system at the time of trailer fitment. Once the geometric relationship of these points are known the system can calculate the non linearity and compensate accordingly.

It should be noted that a non-linearity is also caused by the fact that the rear corner of the trailer is rotating around the fifth wheel, yet the mirror being servo controlled is mounted some distance forwards of this point. This geometry can also be compensated for. To do this compensation requires the X and Y distances of the mirror from the fifth wheel centre to be known, as well as the approximate length of the trailer. These values can be entered at the time of sensor installation in the case of fixed fifth wheels, sliding fifth wheel installations will require the data to be updated as the coupling position is varied.

A sliding fifth wheel arrangement could be equipped with a device for measuring the fifth wheel position relative to the truck chassis and compensating for fifth wheel movement automatically. One way of doing this would be to use ultrasonic transducers mounted on the fifth wheel slide and truck chassis to measure the relative distance variations as the fifth wheel position is adjusted.

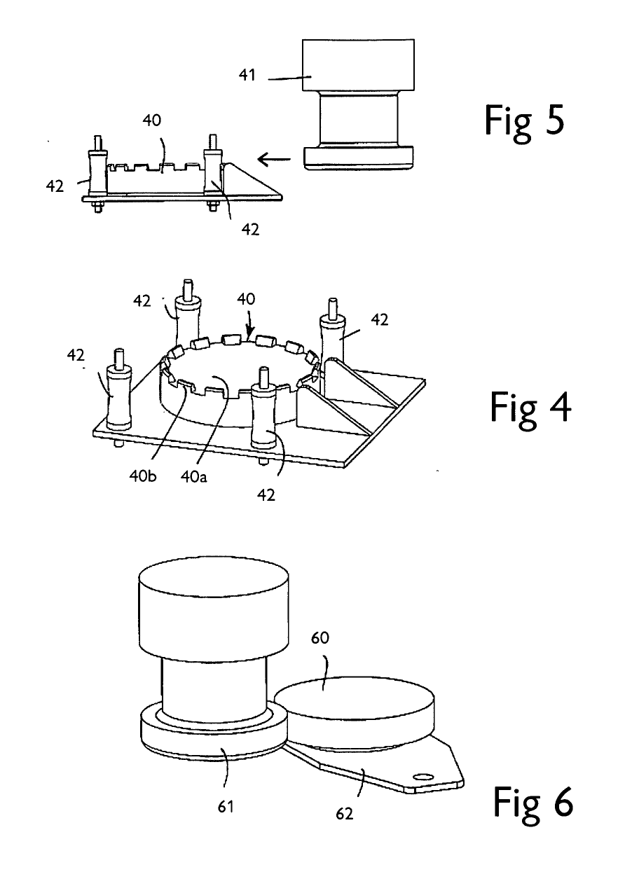

The sensor illustrated in FIGS. 4 and 5 measures the trailer angle by coupling directly to the end of the king pin. It consists of a floating cup 40 that is spring biased to press against the end of the trailer king-pin 41. The cup rotates with the king pin and thus provides the angle measurement. The sensor is housed within the fifth wheel assembly and requires no operator effort during trailer hook-up.

As the exact centre position of the king pin axis relative to the fifth wheel can vary due to play in the bearing system, the sensor must be able to float in a manner that allows the sensor to remain coaxial with the king pin. Failure to achieve this will cause measurement errors and a loss of the system's straight position calibration.

The cup comprises a flat upper surface (40a) bordered by a chamfered rim (40b). Upward pressure against the king pin end causes the cup to centre on the pin due to the effect of the chamfered rim. The contact areas of the cup will be grooved in order to help dissipate grease and dirt, thus ensuring proper contact with the king pin 41. The chamfered rim may be made of a rigid material, or it may comprise sprung fingers to aid contact with the king pin and reduce any tendency to slip.

The rotating cup is arranged so that the king pin 41 can reliably deflect it downwards during trailer coupling without catching its side and causing damage. In the embodiment illustrated in FIG. 4, this is accomplished by the use of ramps mounted on the support plate. An alternative to the use of ramps would be to have a chamfer on the external rim of the rotating cup, serving to deflect the cup downward during trailer coupling. This would, however, increase the overall diameter of the cup.

Another way (not shown) of achieving this will be to allow the cup to pivot forwards and backwards, and spring bias it in the rear pivoted position. As long as the rear edge of the rim is below the lowest possible height of the king pin, the king pin will contact the flat surface of the cup and cause it to be deflected downwards. Once the king pin moves above the cup, it will pivot so that the flat top is parallel to the bottom of the king pin.

The support for the rotating cup is free to move in both longitudinal and transverse directions relative to the vehicle in order to accommodate unwanted movement of the king pin. It is also deflectable downwards, the resistance to this providing the spring bias pressure against the end of the king pin. The support has no rotational play. This may be simply achieved by resilient mountings 42, allowing lateral float as well as serving to bias the cup 40 upwards.

As the rotational position of the sensor is not readily controlled during trailer hook-up, it is preferable to use a rotary sensor that measures relative angle, such as an incremental shaft encoder.

A preferred way of implementing the design would be to use a reflective opto-encoder such as Agilent Technologies HEDR-8000 series. This would be mounted inside a sealed bearing assembly within the sensor cup and would read a radial pattern on the inside face of the cup's flat surface. This will result in an extremely compact and robust construction.

It would be possible to use potentiometer devices but this would be more complex. One potentiometer solution would be to use a multi-turn potentiometer that has a spring mechanism that positions the potentiometer in its mid point. When a new trailer is fitted the potentiometer would begin measuring from a known position. Another potentiometer solution would be to have two electrical tracks within one potentiometer, or two potentiometers coupled together, with the two tracks being 180 degrees apart, and each being able to measure more than 180 degrees of rotation. Assuming no physical stops to limit rotation, it would be possible to ascertain position continually as the potentiometers rotate.

Referring now to FIG. 6, this sensor is similar to the direct coupling king pin sensor shown in FIGS. 4 and 5, in that it mounts within the fifth wheel assembly and measures king pin rotation. Rather than couple to the end of the king pin, it has a roller 60 that is mounted on a lever 62 and spring biased against the circumference of the mushroom end of the king-pin 61 (spring not shown). The roller 60 is provided with rotation sensors, for example as in the embodiment illustrated in FIGS. 4 and 5.

The sensor will mount inside the fifth wheel in a position adjacent to the king pin bearing. When the trailer is coupled, the king pin 61 contacts the roller 60 and deflects it away from the bearing centre. This ensures that the roller is spring biased against the king pin during operation. The deflection distance must be adequate to ensure that contact is not lost when the king pin moves away from the roller due to unwanted play in the coupling. This sensor measures relative position as the starting point of the roller is unknown.

No operator input is required, other than zeroing the system when the vehicle is in the straight position.

Fifth wheel king pins do tend to suffer some damage in the area that this sensor interfaces, although this is not generally serious enough to impede performance to a significant extent. It may require that the system is zeroed more frequently than would otherwise be required.

It offers the possibility of installation in fifth wheel designs that are not suitable for the direct coupling king pin sensor.

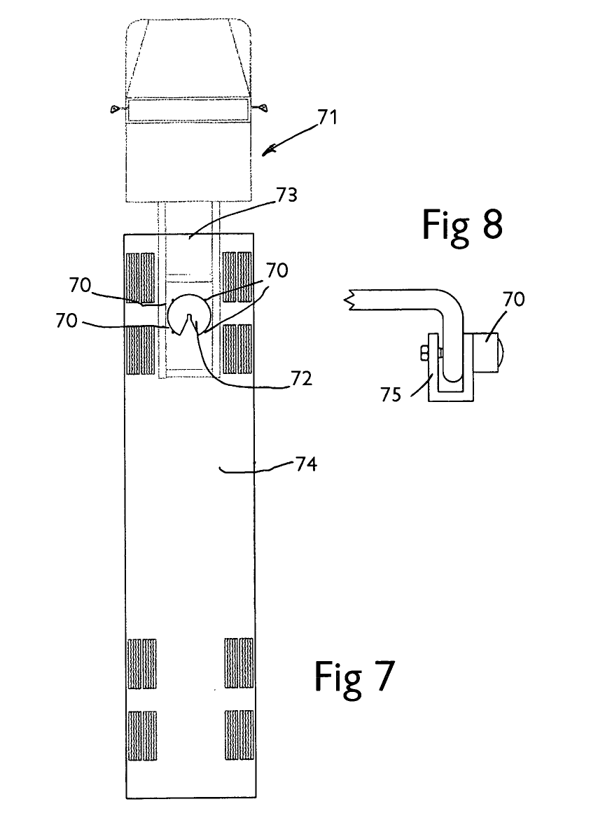

Referring now to FIGS. 7 and 8, the system comprises an array of ultrasonic transducers 70 mounted on the tractor unit 71 in fixed locations around the fifth wheel 72, as well as a single transducer 73 detachably mounted to a suitable point on the trailer 74.

All transducers are connected to a control system which can cause the transducers to emit or receive bursts of ultrasonic sound. The system is capable of measuring the sound flight times between transmitting and receiving transducers.

As the velocity of sound is known, the measured sound flight times can be converted to measurements of distance between individual transducers.

The tractor-mounted transducers 70 are at known distances from the trailer pivot point which is at the centre of the fifth wheel 72. The angle between these transducers relative to the trailer pivot point and the vehicle centre line is also known.

The distance from the trailer-mounted transducer 73 to the trailer pivot must be known to accurately calculate trailer angle. This can be measured by the system. As the trailer rotates relative to the tractor, the system can measure and store the shortest distance between the trailer transducer 73 and any given tractor transducer 70. Adding this value to the known mounting distance of the tractor transducer from the trailer pivot point gives the radius of the arc described by the trailer-mounted transducer.

Prior to collecting the data required for this calculation, an uncorrected value can be measured and used until corrected data is available. This situation will only exist until the vehicle has made the first turn after fitting a new trailer.

Once the mounting geometry of the sensors is known, it is possible to calculate the angle of the trailer mounted transducer relative to the tractor, as well as the direction of turn. The actual trailer angle relative to the tractor can then be derived by comparing the measured angle of the trailer transducer to a known angle entered into the system. A logical way of entering this known angle would be to input a control signal when the tractor and trailer are in line with each other. Any change of trailer sensor from this point would equal trailer turning angle.

The velocity of sound varies with temperature and barometric pressure. If uncorrected, these variations will cause errors in the measurement process with corresponding errors in trailer angle calculations. As the transducers mounted around the fifth wheel are fixed, it will be possible to measure the sound flight time between two of these transducers and periodically recalibrate the sound velocity value used in the system calculations. This method will compensate for both temperature and pressure changes.

The tractor-mounted transducers can be fixed to the outside edge of the fifth wheel with a simple clamp arrangement 75, as shown in FIG. 8. Mounting in this way is advantageous in offering good protection to the transducers as well as ensuring that the mounting geometry will remain constant during use and not be affected by the use of sliding fifth wheels.

The trailer transducer can be mounted at any convenient location, for example using a magnetic mount. As a cable connection may be required to this transducer, a suitable position would be underneath the front of the trailer near the point where the electrical services connect to the trailer. An alternative to a cable connection to the trailer transducer would be to use battery power and a wireless form of communication such as a radio link.

The distances from the fixed transducers to the fifth wheel centre can be determined at the time of installation by using a simple setup tool that holds an ultrasonic transmitter a known length from the fifth wheel centre. As the transmitter is rotated around the fifth wheel at the known radius, the system causes it to transmit ultrasonic pulses which are received by the transducers mounted on the fifth wheel.

The angle of each transducer relative to the tractor can also be measured at this stage and inputted to the system.

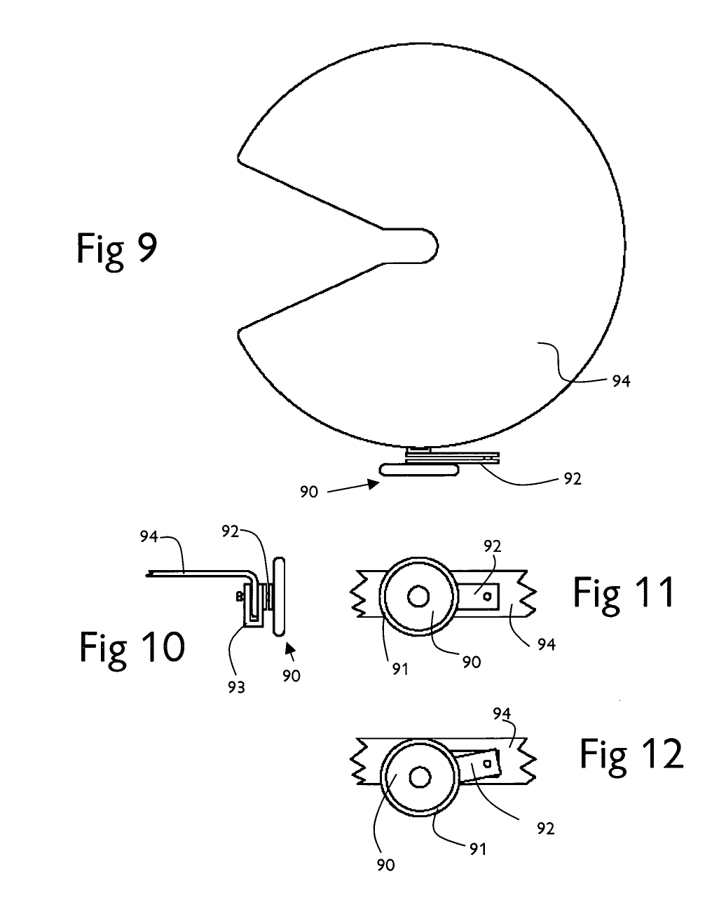

Referring now to FIGS. 9 to 12, an angle sensor according to yet another embodiment of the invention comprises a freely-rotatable wheel 90 provided with a rubber or other gripping tyre or rim 91 and mounted on a pivoting arm 92 which is in turn carried by a bracket 93 clamped on to the side of the slipper plate 94 on the fifth wheel assembly (FIG. 10). Biasing means (not shown), urge the arm upwardly towards the rest position illustrated by FIG. 11, when the trailer is not coupled. When the trailer is coupled on to the tractor, the underside of the trailer around the coupling pin engaged with the clamp underlying the slipper plate contacts the wheel 90, urging it downwardly against the force of the spring, and thus ensuring good contact between the wheel and the underside of the trailer immediately adjacent to the slipper plate. Since the axis of rotation of the wheel 90 lies on a radius from the centre point of the slipper plate, which corresponds to the axis of rotation of the trailer relative to the tractor, such rotation will cause rotation of the wheel 90 as a function of the change of angle between the tractor and trailer. A suitable shaft encoder or other sensor on the wheel 90 or the axle thereof provides an output signal corresponding to the rotation and thus to the change in angle between the tractor and trailer. It will be appreciated that the wheel 90 can be brought even closer to the rim of the slipper plate, if necessary, by mounting the wheel on the arm, and the arm on the mounting, in such a way that the arm is outside of the wheel.

1. (canceled)

2. (canceled)

3. (canceled)

4. (canceled)

5. (canceled)

6. (canceled)

7. (canceled)

8. (canceled)

9. A system for controlling the angle of vehicle rear-view mirrors on an articulated vehicle according to the angle between the tractor and trailer, the system comprising detector means for detecting a change in angle between the tractor and trailer and control means for providing a steering signal to move the mirrors relative to a rest position according to the detected change, the system comprising means for detecting when the tractor and trailer are substantially aligned one with the other, and means for providing a reset signal to return the mirrors to the rest positions thereof in response thereto.

10. A system according to claim 9, comprising means for detecting the speed of the vehicle and for signalling the speed to the control means, and wherein the control means comprises means for providing a reset signal to return the mirrors to the rest positions thereof in response to the detected speed being in excess of a predetermined speed for a predetermined period of time.

11. A system according to claim 9, wherein the control means comprises memory means for storing settings corresponding to the rest position of the mirrors and for adding to the stored settings calculated offset values according to the detected angle between the tractor and trailer, and wherein the reset signal is arranged to set the offset values to zero, thereby causing the mirrors to be returned to the rest positions thereof.

12. A system according to claim 9 comprising a means for measuring changes in angle between the tractor and trailer, the trailer having a generally vertical king pin engaging in a coupling socket therefor on the tractor, and rotatable means engageable with the king pin so as to rotate therewith, and means for generating a signal in response to rotation of the rotatable means.

13. A system according to claim 12, wherein the rotatable means comprises a rotatably mounted contact plate mounted relative to the coupling socket so as to be biased into engagement with the lower end of the king pin so as to rotate therewith.

14. A system according to claim 13, wherein the contact plate is carried by resilient mounting means allowing a degree of movement relative to the coupling device sufficient to permit the contact plate to follow any movement of the king pin relative to the coupling device.

15. A system according to claim 14, wherein the resilient mounting means is clamped to the coupling socket structure.

16. A system according to claim 13, comprising magnetic means for biasing the contact plate into contact with the king pin.

17. A system according to claim 13, wherein the contact plate has an angled rim therearound to assist in centring the contact plate on the end of the king pin.

18. A system according to claim 17, wherein the rim is discontinuous.

19. A system according to claim 17, wherein the rim also comprises a series of springs arranged to grip the king pin.

20. A system according to claim 19, wherein the springs are formed from sheet material.

21. A system according to claim 12, wherein the rotatable means comprises a wheel mounted on a generally vertical axle and biased into engagement with the side of the king pin so as to rotate therewith.

22. A system according to claim 21, wherein the wheel is provided with a surface of rubber or the like.

23. A system according to claim 21, wherein the wheel is biased into engagement with the king pin by means of resilient means co-operating with the axle.

24. A system according to claim 23, wherein the resilient means is a helical spring.

25. A system according to claim 21, wherein the axle is mounted on a lever carried by mounting means attachable to the fifth wheel structure on the tractor.

26. A system according to claim 25, wherein the mounting means comprise clamps or the like which do not require any permanent alteration to the fifth wheel structure.

27. A system according to claim 9 wherein the tractor and trailer have a fifth wheel coupling, the system further comprising a plurality of first ultrasonic transducers mounted around the axis of the coupling at known distances therefrom and at known angles to the longitudinal axis of the tractor, a second ultrasonic transducer mountable on the trailer in a position such that, at any angle between the tractor and the trailer, there is an uninterrupted path between the second transducer and at least two of the first transducers, and control means for causing an ultrasonic signal to be sent between the first and second transducers and for detecting the relative transit times between at least two of the first transducers and the second transducer and for calculating therefrom the instantaneous angle between the tractor and trailer.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)
